(19) United States
(12) Patent Application Publication
(10) Pub. No.: US 2017/0130863 A1
(43) Pub. Date: May 11, 2017

(54) Overfill Protection Device

(71) Applicant: GRAND GAS EQUIPMENT INCORPORATION, TAICHUNG CITY (TW)

(72) Inventor: Chin-Cheng Chang, TAICHUNG CITY (TW)

(21) Appl. No.: 14/934,288

(22) Filed: Nov. 6, 2015

(51) Int. Cl. F16K 31/26; B67D 7/36

(52) U.S. Cl. CPC F16K 31/26; B67D 7/365

(57) ABSTRACT

An overfill protection device includes first and second bodies, a piston slidably mounted within the first body, a spring arranged within the first body and fitted over an intermediate portion of the piston, first and second O-rings respectively fitted in first and second neck portions of the piston, a spindle arranged within the second body and located under the piston, a rod having a cam plate abutted against the spindle, and a float fixedly connected with a lower end of the float rod, whereby no fluid will be allowed to flow through the overfill protection device when the pressure within the vessel exceeds a predetermined level. The first and second bodies are made of plastic and bonded with each other via high frequency welding to prevent a pressurized fluid leak.

### BACKGROUND

The present invention relates to an overfill protection device and, more particularly, to an overfill protection device can prevent the fluid pressure in the vessel to exceed a predetermined level.

U.S. Pat. No. 7,967,025 discloses an overfill protection device including a housing mounted at an opening to a container, a movable piston within the housing, a main valve movable mounted beneath the piston, a retainer mounted to an end of the housing for holding the main valve adjacent the piston, and a level arm consisting of a rising faced section and a U-shaped section, whereby no fluid will be allowed to flow through the overfill protection device when the fluid reaches the predetermined 80 percent level. The housing has a female thread, and the retainer has the male thread screwed with the female thread of the housing.

However, a pressurized fluid leak will occur from a gap formed between the female and male threads easily.

Thus, a need exists for a novel overfill protection device to mitigate and/or obviate the above disadvantages.

### BRIEF SUMMARY

This need and other problems in the field of overfill protection devices are solved by an overfill protection device including a first body, a second body, a piston, a spring, a first O-ring, a second O-ring, a spindle, a rod, and a float.

The first body is made of plastic and includes a first upper portion adapted to connect to a valve, a first intermediate portion connected to the first upper portion, and a first lower portion connected to the first intermediate portion. The first upper portion has a first axial through hole. The first intermediate portion has a second axial through hole interconnected with the first axial through hole. The first lower portion includes a third axial through hole interconnected with the second axial through hole, a first joining section formed at an end face thereof, and an annular groove formed between the second and third axial through holes.

The second body is made of plastic and includes a second upper portion, a second intermediate portion connected to the second upper portion, and a second lower portion connected to the second intermediate portion. The second upper portion includes a first recess open at a top thereof and engaged with a lower end of the first lower portion of the first body, and a second joining section formed at an end face thereof and bonded with the first joining section of the lower portion of the first body via high frequency welding. The second intermediate portion has a fourth axial through hole interconnected with the third axial through hole of the lower portion of the first body. The second lower portion has a fifth axial through hole interconnected with the fourth axial through hole, and the second lower portion is divided by a diametrical slot.

The piston is slidably mounted within the first body and includes a third upper portion, a third intermediate portion connected to the third upper portion, a third lower portion connected to the third intermediate portion, a first neck portion located between the third upper and intermediate portions, a second neck portion located on the third lower portion, and a second recess formed at a bottom of the third lower portion. The third upper portion is dimensioned to fit into the first axial through hole and has a first through bore interconnected with the second axial through hole. The third intermediate portion is dimensioned to fit the second axial through hole. The third lower portion is dimensioned to fit into the third axial through hole. The first neck portion has a second through bore interconnected with the first through bore. A third through bore is formed in the third intermediate and lower portions and has upper and lower ends respectively intercommunicated with the second through bore and the second recess.

The spring is arranged in the third axial through hole of the first lower portion of the first body and fitted over the third intermediate portion of the piston. The spring has upper and lower ends respectively bearing against the annular groove of the first body and the lower portion of the piston.

The first O-ring is fitted in the first neck portion of the piston.

The second O-ring is fitted in the second neck portion of the piston.

The spindle includes a fourth upper portion formed with a third neck portion fitted with a third O-ring, and a fourth lower portion formed with a conical lower end. The spindle is arranged within the fourth and fifth axial through holes of the second body and located under the second recess of the piston.

The rod includes a cam plate at an upper end thereof. The cam plate is fitted into the diametrical slot of the second body and is pivotally connected thereto by a rivet extending through the second body and the cam plate.

The cam plate is abutted against the conical lower end of the spindle and is contoured to form a lobe, a convex edge and a concave edge.

a float is fixedly connected with a lower end of the rod.

Illustrative embodiments will become clearer in light of the following detailed description described in connection with the drawings.

### DESCRIPTION OF THE DRAWINGS

The illustrative embodiments may best be described by reference to the accompanying drawings where:

FIG. 1 is a perspective view of an overfill protection device according to the present invention.

FIG. 2 is a partial cross-sectional view of the overfill protection device of FIG. 1.

FIG. 3 is an enlarged view of a portion of FIG. 2.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “third”, “fourth”, “bottom”, “side”, “end”, “portion”, “section”, “spacing”, “length”, “depth”, “thickness”, and similar terms are used herein, it should be understood that these terms have reference only to the structure shown in the drawings as it would appear to a person viewing the drawings and are utilized only to facilitate describing the illustrative embodiments.

### DETAILED DESCRIPTION

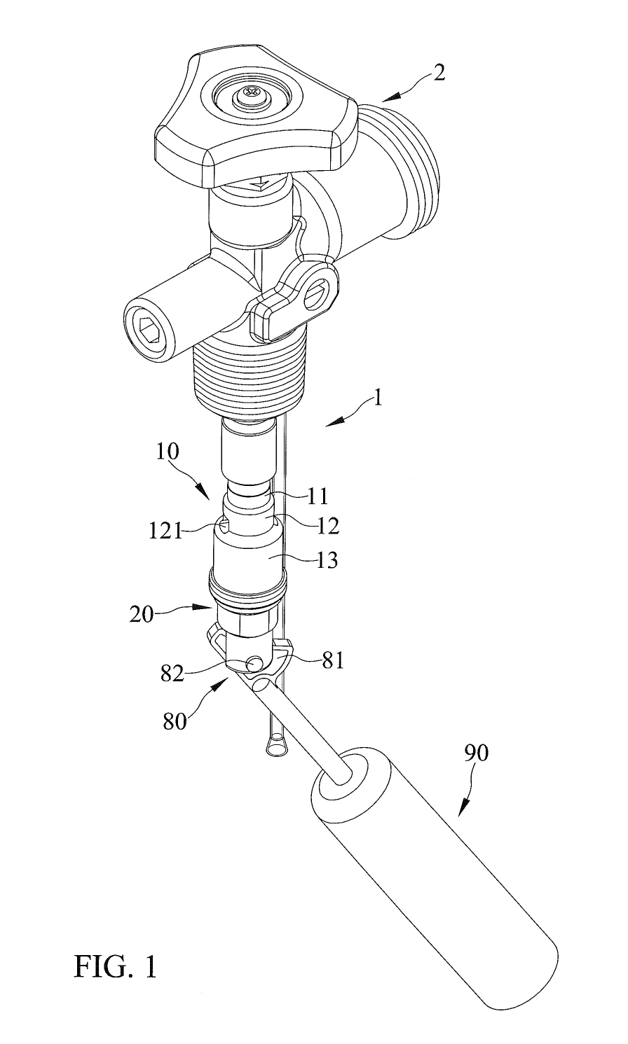

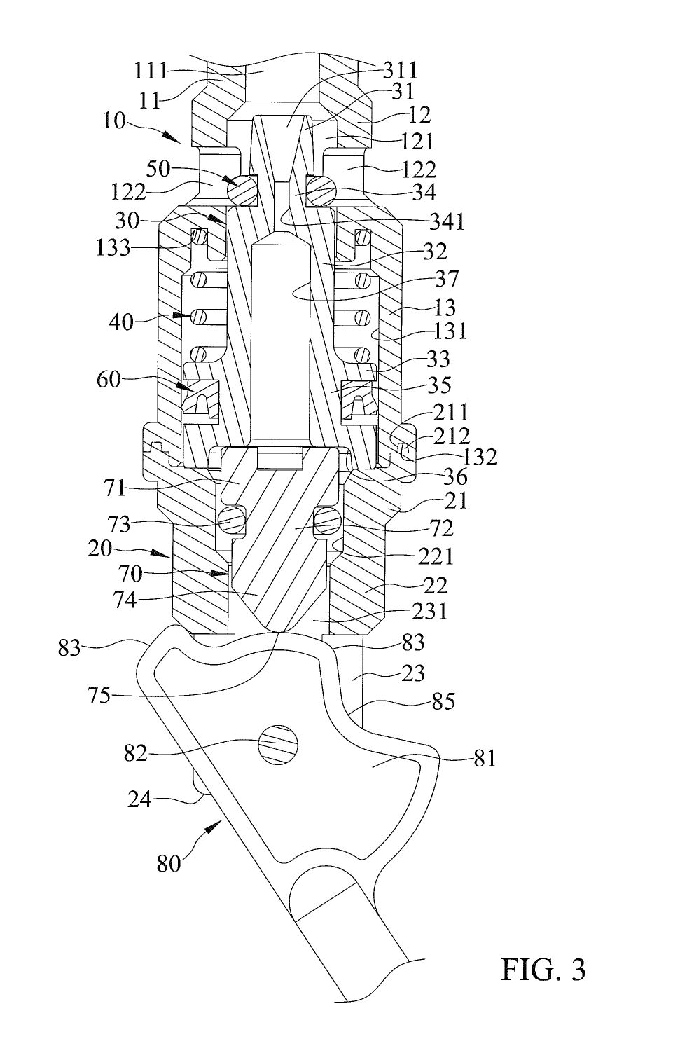

FIGS. 1-3 show an overfill protection device 1 according to the present invention. The overfill protection device 1 is adapted for connecting to a valve 2 and includes a first body 10, a second body 20, a piston 30, a spring 40, a first O-ring 50, a second O-ring 60, a spindle 70, a rod 80, and a float 90.

The first body 10 is made of plastic and includes a first upper portion 11 adapted to connect to a valve 2, a first intermediate portion 12 connected to the first upper portion 11, and a first lower portion 13 connected to the first intermediate portion 12. The first upper portion 11 has a first axial through hole 111. The first intermediate portion 12 has a second axial through hole 121 interconnected with the first axial through hole 111. In the embodiment, the second axial through hole 121 of the first intermediate portion 12 has a diameter larger than a diameter of the first axial through hole 111 of the first upper portion 11. In the embodiment, the first intermediate portion 12 includes two radial through holes 122 arranged opposite to each other and interconnected with the second axial through hole 121. The first lower portion 13 includes a third axial through hole 131 interconnected with the second axial through hole 121, a first joining section 132 formed at an end face thereof, and an annular groove 133 formed between the second and third axial through holes 121 and 131. In the embodiment, the first joining section 132 of the lower portion 13 is an annular slot.

The second body 20 is made of plastic and includes a second upper portion 21, a second intermediate portion 22 connected to the second upper portion 21, and a second lower portion 23 connected to the second intermediate portion 22. The second upper portion 21 includes a first recess 211 open at a top thereof and engaged with a lower end of the first lower portion 13 of the first body 10, and a second joining section 212 formed at an end face thereof and bonded with the first joining section 132 of the lower portion 13 of the first body 10 via high frequency welding. In the embodiment, the second joining section 212 of the second upper portion 21 is an annular protrusion engaged and bonded with the first joining section 132 of the lower portion 13. The second intermediate portion 22 has a fourth axial through hole 221 interconnected with the third axial through hole 131 of the lower portion 13 of the first body 10. The second lower portion 23 has a fifth axial through hole 231 interconnected with the fourth axial through hole 221. In the embodiment, the fourth axial through hole 221 of the second intermediate portion 22 has a diameter larger than a diameter of the fifth axial through hole 231 of the second lower portion 23. The second lower portion 23 is divided by a diametrical slot 24.

The piston 30 is slidably mounted within the first body 10 and includes a third upper portion 31, a third intermediate portion 32 connected to the third upper portion 31, a third lower portion 33 connected to the third intermediate portion 32, a first neck portion 34 located between the third upper and intermediate portions 31 and 32, a second neck portion 35 located on the third lower portion 33, and a second recess 36 formed at a bottom of the third lower portion 33. The third upper portion 31 is dimensioned to fit into the first axial through hole 111 and has a first through bore 311 interconnected with the second axial through hole 121. The third intermediate portion 32 is dimensioned to fit the second axial through hole 121 and has a diameter larger than a diameter of the third upper portion 31. The third lower portion 33 is dimensioned to fit into the third axial through hole 131 and has a diameter larger than the diameter of the third intermediate portion 32. The first neck portion 34 has a second through bore 341 interconnected with the first through bore 311 and having a diameter to be equal to a diameter of a lower end of the first through bore 311 of the third upper portion 31. A third through bore 37 is formed in the third intermediate and lower portions 32 and 33 and has upper and lower ends respectively intercommunicated with the second through bore 341 and the second recess 36.

The spring 40 is arranged in the third axial through hole 131 of the first lower portion 13 and is fitted over the third intermediate portion 32 of the piston 30. The spring 40 has upper and lower ends respectively bearing against the annular groove 133 of the first body 10 and the lower portion 33 of the piston 30.

The first O-ring 50 is fitted in the first neck portion 34 of the piston 30.

The second O-ring 60 is fitted in the second neck portion 35 of the piston 30.

The spindle 70 includes a fourth upper portion 71 formed with a third neck portion 72 fitted with a third O-ring 73, and a fourth lower portion 74 formed with a conical lower end 75. The spindle 70 is arranged within the fourth and fifth axial through holes 221 and 231 of the second body 20 and is located under the second recess 36 of the piston 30.

The rod 80 includes a cam plate 81 at an upper end thereof. The cam plate 81 is fitted into the diametrical slot 24 of the second body 20 and is pivotally connected thereto by a rivet 82 extending through the second body 20 and the cam plate 81. The cam plate 81 is abutted against the conical lower end 75 of the spindle 70 and contoured to form a lobe 83, a convex edge 84, and a concave edge 85.

The float 90 is fixedly connected with a lower end of the rod 80.

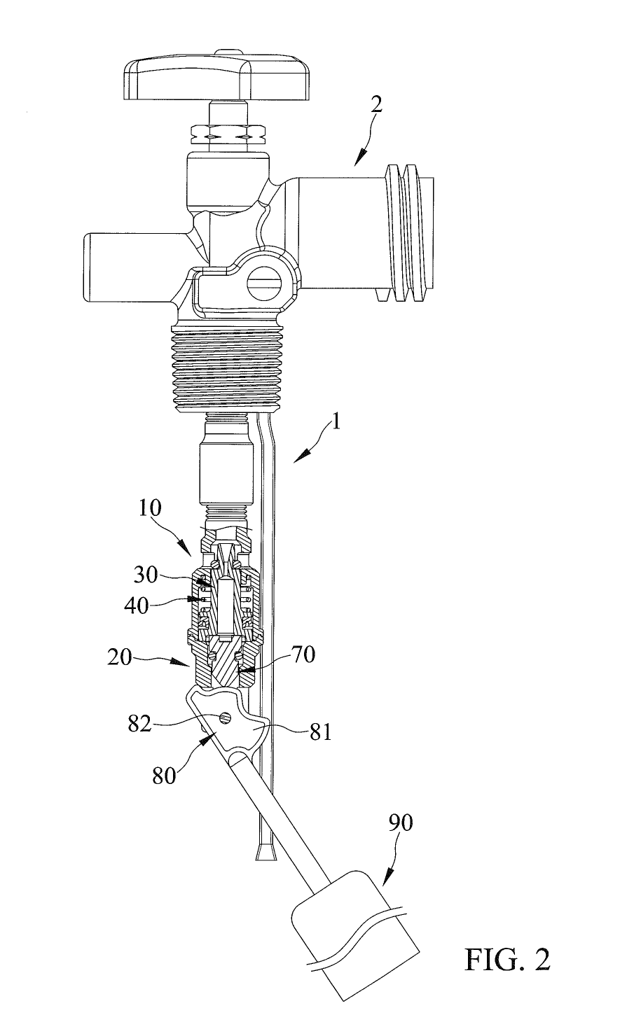

When in use, the first upper portion 11 of the first body 10 is connected to a valve 2. When the valve 2 is turned open, fluid will flow through the valve 2 and the overfill protection device 1 into a vessel. The float 90 will be positioned as shown in FIG. 2 when pressurized fluid is being filled into the vessel. As shown in FIG. 2, the lobe 83 of the cam plate 81 of the rod 80 abuts against the second intermediate portion 22 of the second body 20 thereby disposing the rod 80 at an inclined position with respect to the second body 20, while the convex edge 84 of the cam plate 81 is in contact with the conical lower end 75 of the spindle 70 thereby preventing the spindle 70 from moving downwardly to close the fifth axial through hole 231 of the second body 20 and therefore enabling the fluid to flow through the first body 10, the piston 30 and the second body 20 into the vessel. Meanwhile, the spring 40 pushes the piston 30 to move downwardly against the second body 20 hence enabling the fluid to flow through the first body 10 and the two radial through holes 122 into the vessel. The fluid flowing through the two radial through holes 122 can prevent more backflow of the fluid in the vessel to rotate the float 90 upwardly with respect to the second body 20, resulting in the spindle 70 to be pushed by the fluid to go downwardly to prematurely close the fifth axial through hole 231 of the second body 20 at a wrong predetermined level.

However, as the pressure within the vessel reaches the predetermined level, the float 90 will be rotated upwardly with respect to the second body 20 thereby moving the concave edge 85 of the cam plate 81 of the float rod 80 to the position right under the conical lower end 75 of the spindle 70 and therefore causing the spindle 70 to be pushed by the fluid to go downwardly to close the fifth axial through hole 231 of the second body 20. As the fluid cannot flow through the second body 20, it will be forced to go upwardly thereby lifting the piston 30 until the first O-ring 50 bears against the first axial through hole 111 of the first body 10 and the two radial through holes 122 are closed by the third intermediate portion 32 of the piston 30. Hence, no more fluid is allowed to flow through the overfill protection device 1 a when the pressure within the vessel exceeds the predetermined level. Moreover, the first and second bodies 10 and 20 are made of plastic and are bonded with each other via high frequency welding to prevent a pressurized fluid leak.

Thus since the illustrative embodiments disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

1. An overfill protection device comprising:
a first body made of plastic, with the first body including a first upper portion adapted to connect to a valve, a first intermediate portion connected to the first upper portion, and a first lower portion connected to the first intermediate portion, with the first upper portion having a first axial through hole, with the first intermediate portion having a second axial through hole interconnected with the first axial through hole, with the first lower portion including a third axial through hole interconnected with the second axial through hole, a first joining section formed at an end face thereof, and an annular groove formed between the second and third axial through holes;
a second body made of plastic, with the second body including a second upper portion, a second intermediate portion connected to the second upper portion, and a second lower portion connected to the second intermediate portion, with the second upper portion including a first recess open at a top thereof and engaged with a lower end of the first lower portion of the first body, and a second joining section formed at an end face thereof and bonded with the first joining section of the lower portion of the first body via high frequency welding, with the second intermediate portion having a fourth axial through hole interconnected with the third axial through hole of the lower portion of the first body, with the second lower portion having a fifth axial through hole interconnected with the fourth axial through hole, with the second lower portion divided by a diametrical slot;
a piston slidably mounted within the first body and including a third upper portion, a third intermediate portion connected to the third upper portion, a third lower portion connected to the third intermediate portion, a first neck portion located between the third upper and intermediate portions, a second neck portion located on the third lower portion, and a second recess formed at a bottom of the third lower portion, with the third upper portion dimensioned to fit into the first axial through hole and having a first through bore interconnected with the second axial through hole, with the third intermediate portion dimensioned to fit the second axial through hole, with the third lower portion dimensioned to fit into the third axial through hole, with the first neck portion having a second through bore interconnected with the first through bore, with a third through bore formed in the third intermediate and lower portions and having upper and lower ends intercommunicated with the second through bore and the second recess;
a spring arranged in the third axial through hole of the first lower portion of the first body and fitted over the third intermediate portion of the piston, with the spring having upper and lower ends respectively bearing against the annular groove of the first body and the lower portion of the piston;
a first O-ring fitted in the first neck portion of the piston;
a second O-ring fitted in the second neck portion of the piston;
a spindle including a fourth upper portion formed with a third neck portion fitted with a third O-ring, and a fourth lower portion formed with a conical lower end, with the spindle arranged within the fourth and fifth axial through holes of the second body and located under the second recess of the piston;
a rod including a cam plate at an upper end thereof, the cam plate fitted into the diametrical slot of the second body and pivotally connected thereto by a rivet extending through the second body and the cam plate, with the cam plate abutted against the conical lower end of the spindle and contoured to form a lobe, a convex edge, and a concave edge; and
a float fixedly connected with a lower end of the rod.

2. The overfill protection device as claimed in claim 1, with the first joining section of the lower portion of the first body being an annular slot, and with the second joining section of the second upper portion of the second body being an annular protrusion engaged and bonded with the first joining section of the lower portion of the first body.

3. The overfill protection device as claimed in claim 1, with the first intermediate portion of the first body including two radial through holes arranged opposite to each other and interconnected with the second axial through hole.

4. The overfill protection device as claimed in claim 1, with the second axial through hole of the first intermediate portion having a diameter larger than a diameter of the first axial through hole of the first upper portion.

5. The overfill protection device as claimed in claim 1, with the fourth axial through hole of the second intermediate portion having a diameter larger than a diameter of the fifth axial through hole of the second lower portion.

6. The overfill protection device as claimed in claim 1, with the third intermediate portion having a diameter larger than a diameter of the third upper portion.

7. The overfill protection device as claimed in claim 6, with the third lower portion having a diameter larger than the diameter of the third intermediate portion.

8. The overfill protection device as claimed in claim 1, with the second through bore of the first neck portion having a diameter being equal to a diameter of a lower end of the first through bore of the third upper portion.
